(19) United States
(12) Patent Application Publication
(10) Pub. No.: US 2005/0075445 A1
(43) Pub. Date: Apr. 7, 2005

(54) Cationic coating for printable surfaces

(76) Inventors: Philip A. Confalone, Raritan, NJ (US); Rajeev Farwaha, Belle Mead, NJ (US)

Correspondence Address: Charles W. Almer;National Starch and Chemical, 10 Finderne Avenue, Bridgewater, NJ, 08807, US

(21) Appl. No.: 10/963,965

(22) Filed: Oct. 13, 2004

Related U.S. Application Data
(63) Continuation-in-part of application No. 10/152,359, filed on May 20, 2002.

(51) Int. Cl. C08K 3/00

(52) U.S. Cl. 524/543; 524/13

(57) ABSTRACT

The present invention relates to a coating composition for fibrous substrates made up of 0.5 to 25 percent by weight of a water-insoluble emulsion polymer comprising from greater than 0.4 to 3 mole percent of one or more cationic monomer units and at least 50 mole percent of at least one vinyl ester monomer; 25 to 75 percent by weight pigment; cationic surfactant; and water. The coating is useful on fibrous substrates on which liquid inks will be fixed. The cationic nature of the coating provides the substrate with an excellent point of attachment for anionic inks and dyes, resulting in bright, crisp printed images. The coating is especially useful for ink-jet printing on paper, paperboard, textiles, non-wovens, and wood.

### FIELD OF THE INVENTION

This invention relates to a cationic coating for printable surfaces. In particular, the coating composition contains an emulsion polymer having from greater than 0.4 to 3 mole percent of a cationic monomer, and at least 50 mole percent of one or more vinyl ester monomers. The coating is useful on fibrous substrates on which liquid inks will be fixed. The cationic nature of the coating provides the substrate with an excellent point of attachment for anionic inks and dyes, resulting in bright, crisp printed images. The coating is especially useful for ink-jet printing on paper, paperboard, textiles, non-wovens, and wood.

### BACKGROUND OF THE INVENTION

Fibrous substrates, such as paper, are coated to produce a smoother and less absorbent surface on which to apply printing inks and other functional coatings. The coating composition typically comprises naturally occurring or man-made pigments, synthetic or natural polymer coating binders, water, and small amounts of miscellaneous additives. The pigments are used to fill and smooth the uneven surface of the fibrous paper web, while the binder is used to hold the pigment particles together and to hold the coating layer to the paper. Typical paper coating binders are composed of synthetic polymers, natural polymers, or a mixture of these components.

Coating compositions containing polymers having low levels of tertiary amine functionality, up to 0.4 mole percent, are disclosed in U.S. Pat. No. 4,944,988. U.S. Pat. No. 5,660,928 discloses a multi-layer paper coating for ink jet printing which contains as a third layer a cationic water soluble polymer. In the examples this cationic layer is so thin as to not be measured.

U.S. Pat. No. 6,153,288 describes a multi-polymer paper coating having a blend of an ethylene-vinyl acetate polymer and a water-soluble cationic polymer. The cationic polymer makes up from 5 to 50 percent of the coating formulation, and may be a water-soluble copolymer containing quaternary dimethylaminoethyl acrylate or methacrylate. Other water-soluble polymers, such as polyvinyl alcohol and polyvinyl pyrrolidone are used in paper coatings. Unfortunately, these coatings are sensitive to moisture and difficult to use in humid environments. Polyvinyl alcohol has the disadvantage of requiring cooking to form a usable solution, plus it is difficult to maximize a coating solids using polyvinyl alcohol. Polyvinyl pyrrolidone coatings are expensive and are prone to yellowing.

U.S. Pat. No. 6,194,077 describes low molecular weight water insoluble cationic polymers used with gelatin and a crosslinking agent, for use in paper coatings.

U.S. Pat. No. 6,358,306 discloses an ink-jet recording sheet having a water-insoluble resin with hydrophilic groups and tertiary amino groups at up to 5 percent by weight. The resins are condensation polymers of polyurethanes, polyureas, and polyamides, form by solution polymerization in organic solvents.

Cationic emulsions for inkjet paper are described in JP 11123867. These emulsions are acrylic-based emulsions.

There is a need for a water-based, water insoluble synthetic polymer coating compositions for paper and other fibrous substrates that has higher levels of cationicity than current formulations, to provide greater ink retention and an improvement in other print characteristics. Surprisingly it has been found that water insoluble synthetic emulsion polymers having at least 50 mole percent vinyl ester monomer and with cationic monomer levels above 0.4 mole percent may be used to produce stable coating compositions which, when applied to a substrate provide excellent fixation of liquid inks.

### SUMMARY OF THE INVENTION

The invention is also directed to a coating composition for fibrous substrates comprising:

a) 0.5 to 25 percent by weight of a water-insoluble emulsion polymer comprising from greater than 0.4 to 3 mole percent of one or more cationic monomer units, and at least 50 mole percent of one or more vinyl ester monomer;

b) 25 to 75 percent by weight pigment;

c) water; and

d) cationic surfactant.

The coating composition may also contain other miscellaneous additives. Preferably the cationic monomer is one or more primary, secondary, or tertiary amine monomers

The invention is further directed to a coated fibrous substrate having on at least one surface a coating composition containing the cationic polymer, and also to a process for producing coated substrate. The coated substrate can further comprise an ink or dye associated with the coating, following a printing or dying process.

### DETAILED DESCRIPTION OF THE INVENTION

The coating composition of the present invention contains pigment, cationic emulsion polymer, water and cationic surfactant.

The cationic emulsion polymer contains at least 50 mole percent of one or more vinyl ester monomers, 0 to 49.4 mole percent of one or more other ethylenically unsaturated monomer(s), and greater than 0.4 to 3 mole percent of one or more cationic monomer(s), including 0.5 to 3 mole percent of cationic monomer, 0.6 to 3 mole percent of the cationic monomer and 0.7 to 3 mole percent of the cationic monomer. Preferably the polymer contains 0.5 to 2 mole of cationic monomer, although it also may contain greater than 0.5 to 2 mold of cationic monomer. Preferred cationic monomers include primary, secondary, or tertiary amines. Examples of such monomers include, but are not limited to, N,N dialkylaminoalkyl(meth)acrylate; N,N, dialkylaminoalkyl (meth)acrylamide; and N,N dialkylminoalkylacrylamide, where the alkyl groups are independently C₁₋₁₈. Aromatic amine containing monomers such as vinyl pyridine may also be used. Furthermore, monomers such as vinyl formamide, vinylacetamide etc which generate amine moieties on hydrolysis may also be used. Preferably the hydrophilic acid-neutralizable monomer is N,N-dimethylaminoethyl (meth)acrylate, and N,N-dimethylaminopropyl (meth)acrylamide. Cationic monomers that may be used are the quarternized derivatives of the above monomers as well as diallyldimethylammonium chloride, methacrylamidopropyl trimethylammonium chloride. Preferred monomers are the N,N dialkylaminoalkylacrylates and N,N dialkylaminoalkylmethacrylates. Especially preferred is dimethylaminoethyl methacrylate. If the level of cationic functionality is too great, the polymer can become water-soluble and act as a thickener, rather remaining as a water-insoluble polymer of the invention.

The cationic polymer contains at least 50 mole percent of one or more vinyl ester monomers, preferably at least 70 mole percent, and most preferably at least 80 mole percent vinyl ester monomers. Suitable vinyl esters include, but are not limited to, vinyl acetate, vinyl formate, vinyl propionate, vinyl butyrate, vinyl isobutyrate, vinyl valerate, and vinyl 2-ethylhexanoate. Preferred polymers are those vinyl acetate homopolymers, and ethylene-vinyl acetate copolymers with the cationic monomer. Since the vinyl ester monomers are hydrophilic, it is therefore difficult to copolymerize these with nitrogen-containing cationic polymers due to the tendency toward hydrolysis of the vinyl ester. The polymers of the present invention have been found to have no noticable deterioration even at levels of over 1 mole percent of the cationic functionality, and up to 3 mole percent.

Suitable other ethylenically unsaturated monomers present at a level of 0 to 48.6 mole percent in the cationic polymer include, but are not limited to, maleates, (meth)acrylamides, itaconates, styrenics, unsaturated hydrocarbons and acrylonitrile, nitrogen functional monomers, alcohol functional monomers, unsaturated hydrocarbons, and (meth)acrylates. Only minor amount of carboxylic acids or other acid monomers should be used, if at all, due to the detrimental effect caused by any reaction between the acid functionality and the amine functionality.

Small amounts of cross-linking monomers, such as N-methylol acrylamide may also be present in the polymer. Slightly cross-linked polymers are especially useful in textile printing processes. The cationic polymer emulsions are water insoluble, and are capable of forming films that are insoluble in water.

The cationic emulsion polymers of the present invention are high molecular weight polymers, with weight average molecular weights of greater than 100,000, and preferably greater than 500,000.

The polymer is formed by emulsion polymerization processes known in the art forming an aqueous latex or dispersion polymer system. The emulsion process may be batch, semi-batch or continuous, and preferably includes monomer feeds over several hours. Preferably the cationic monomer(s) will be added slowly over the course of the polymerization. The emulsion may be formed by the use of seed polymers for control of particle size. The emulsion may be stabilized with surfactants, colloidal stabilizers, or a combination thereof. One preferred stabilizer is polyvinyl alcohol. Some or all of the polyvinyl alcohol may be cationically functional. The stabilizer can function both to stabilize the polymer particles in the emulsion/dispersion, and also serves to stabilize a coating composition in which the emulsion polymer is used as a binder. It has also been found that the surfactant in the coating composition aids in the adhesion of the coating to substrates, especially substrates composed of synthetic fibers.

The polymer dispersion is combined with pigment and other additives to form a paper-coating composition. A typical ink-jet paper coating composition contains 55 to 80 percent by weight of inorganic pigments. The choice of pigment is based on the properties required in the paper surface. The cationic binder is generally used with non-ionic pigments such as silica, since highly anionic pigments like calcium carbonate may precipitate the cationic binder. Preferred silica pigments for paper coatings are those having particle sizes in a range from 4 to 14 microns. The coating composition further contains 10 to 30 percent by weight of a binder; 2 to 9 percent by weight of cobinders such as protein, casein, and starch; 0.1 to 1.5 percent by weight of other additives; cationic surfactant; and 25 to 45 percent by weight of water. The binder may be entirely composed by the cationic emulsion binder, or can be a blend of the cationic binder of the invention with other natural or synthetic polymer binders such as polyvinyl alcohol or polyvinyl pyrrolidine;

Other additives that may be incorporated into a coating composition include, but are not limited to, thickening agents, parting agents, penetrating agents, wetting agents, thermal gelling agents, sizing agents, defoaming agents, foam suppressors, blowing agents, coloring matters, fluorescent whiteners, ultra violet absorbers, oxidation inhibitors, quenchers, antiseptic agents, dispersants, insolubilizers (to improve wet strength), antistatic agents, crosslinking agents, dispersants, lubricants, plasticizers, pH regulators, flow improvers, setting promoters, and water-proofing agents.

The coating composition is formulated by combining the pigment, binder, cobinder and other additives with water under low shear. The minor coating additives are generally added last.

The Tg of the coating composition should be about room temperature. This can be accomplished either by synthesizing a polymer having a Tg in the range of from 0 to 50° C., or by use of a higher Tg polymer plus plasticizer, as known in the art.

The coating may be applied to one or more surfaces of a fibrous substrate, for use as an ink- or dye-receptive surface. Examples of fibrous substrates include, but are not limited to paper, paperboard, wood, leather, skin, hair, textiles, non-wovens. Textiles and non-wovens may be formed from natural and/or synthetic fibers. Paper includes any paper that will receive ink or dye, including printer paper, as well as printed papers such as wallpaper, wrapping papers.

The polymer coating composition can be applied to one or more sides of the substrate by any means known in the art. Paper-coating methods include, but are not limited to, roll applicator and metering with roll, rod, blade, bar, or air knife; pond applicator and metering with roll, rod, blade, bar, or air knife; fountain applicator and metering with roll, rod, blade, or bar, or air knife; premetered films or patterns (e.g., gate roll, three-roll, anilox, gravure, film press, curtain, spray); and foam application. Examples of such processes include, but are not limited to, film-press methods in which paper is fed through rollers which have been coated with the coating composition, and which is transferred to the paper surface under pressure. The thickness of the coating is controlled by the thickness of the coating composition applied to the rollers. The coating compositions may be applied to a variety of other substrates by spraying, brushing, foaming, and immersing.

The coated surface contains cationic functionality that tends to hold inks and dyes, thereby reducing migration of the ink or dye. The cationic polymer in the coating formulation helps to improve printability. Inks and dyes that will be contacted with the substrate surface are fixed dyes, and may be water-based or solvent-based. The dyes tend to be anionic, thus are attracted to the cationic coating composition.

The following examples are presented to further illustrate and explain the present invention and should not be taken as limiting in any regard.

### EXAMPLE 1

A cationic PVA was prepared according to the formula and procedure given below:

| | Concentration in |
|---|---|
| Ingredients | Parts Per Hundred Monomer |
| Initial Charge | |
| Water | 72.58 |
| 10% AIRVOL A-523 | 40.0 |
| DISPONIL 3065 | 6.0 |
| Ammonyx Cetyl (cationic surfactant) | 3.0 |
| Catalyst Shot | |
| Water | 4.15 |
| Ammonium Persulfate | 0.06 |
| Monomer Slow-add | |
| Vinyl Acetate | 99.1 |
| Dimethyl aminoethyl methacrylate | 0.9 |
| Catalyst Slow-add | |
| Water | 10.0 |
| Ammonium Persulfate | 0.3 |
| Scavenger Slow-add | |
| Water | 1.22 |
| t-BHP | 0.10 |
| Scavenger Slow-add | |
| Water | 1.42 |
| SFS | 0.07 |

In a 2 Liter vessel equipped with a reflux condenser, additional funnels, and stirrer. An initial charge was added to the reactor and the reaction contents were heated to 60° C. Initial catalyst shot was added at 60° C. and the monomer slow-add was added for 3.75 hours. The temperature of the reaction was increased to 75° C. and catalyst slow-add was added for 4 hrs. The reaction content were held at 75° C. for 20 minutes. The reaction mass was cooled to 65° C. and scavenger shots were introduced. The reaction mass was discharged at room temperature. The following physical properties were obtained: % Solids 44.78; Viscosity 3300 cps; pH 4.5; Grits (200M) 0.006.

### EXAMPLE 2

### (Comparative)

An emulsion polymer was synthesized by the process of Example 1 except having 0.32 mole percent of dimethyl aminoethyl methacrylate. The following physical properties were obtained: % Solids 45; Viscosity 4000 cps; pH 3.8; Grits(200M) 0.005.

### EXAMPLE 3

An emulsion polymer of ethylene and vinyl acetate was synthesized employing the surfactant system of example 1 (with 2 pphm Ammonyx Cetyl). The following physical properties were obtained: % solids 52.5; Viscosity: 100 cps; pH 3.0; Grits(200M) 0.002.

### EXAMPLE 4

An emulsion polymer of polyvinyl acetate was synthesized by process of example 1 except having 2.0 mole percent of dimethyl amino ethyl methacrylate, and containing no cationic surfactant. The following physical properties were obtained: % Solids 45.3; Viscosity: 835 cps; pH 4.4; Grits (200M) 0.001.

### EXAMPLE 5

### Preparation of Inkjet Recording Sheet

A coating composition was formed by combining about 80 percent by weight of an amorphous synthetic silica slurry having a particle size of about 10 microns, 10 percent by weight of the emulsion polymers and 10 percent water to form a coating composition. The exact formulations used were:

6A: 666.7 g 15% solids silica slurry having a particle size of 10 microns

110.9 g water
55.8 g Emulsion polymer of Example 1
   6B: 666.7 g 15% solids silica slurry having a particle size of 10 microns
111.1 g water
55.6 g Emulsion polymer of Example 2
   6C: 666.7 g 15% solids silica slurry having a particle size of 10 microns
119 g water
47.6 g Emulsion polymer of Example 3
   6D: 666.7 g 15% solids silica slurry having a particle size of 10 microns
111.5 g water
55.2 g Emulsion polymer of Example 4
   6E: (Control)
666.7 g 15% solids silica slurry having a particle size of 10 microns
13.3 g water
153.4 g 20% solution of fully hydrolysed polyvinyl alcohol
   The coating composition had a pH of 6.0. The coating compositions were coated onto paper at 22° C. to produce a coating weight of 3 to 5 pounds per ream.

### EXAMPLE 6

### Test Results

The following tests were performed on the coated inkjet recording sheets of Example 5

1. Optical density is the degree of darkness and/or spectural reflectance of printed colors as measured by a MACBETH RD-514 Reflection Densitometer for each of the listed colors.

2. Percent show through is the undesirable appearance of a printed image on the opposite side of the printed substrate. It was measured by optical density (OD), followed the calculation: percent showthrough=(OD printed side−OD reverse side) divided by OD printed side, ×100.

3. Print gloss is the reflection (specular gloss) of light off of a printed ink film at an angle of incident light measured print gloss using a Hunter glossmeter at 75 degrees.

4. Print definition is the text quality and/or sharpness as measured by optical density and total area/perimeter measurements. Wicking and/or feathering caused by spreading of the ink is undesirable.

5. Color bleed is the spreading of one color into another, as measured by optical density and total area/perimeter measurements.

### EXAMPLE

| | | 6B | | | 6E |
|---|---|---|---|---|---|
| | 6A | (Comp) | 6C | 6D | (Control) |
| Polymer Composition | | | | | |
| Amine monomer (pphm) | 0.7 | 0.32 | x | 2.0 | x |
| Cationic Surfactant | 0.75 | 0.75 | 0.5 | x | x |

Test results:

| | | | | | |
|---|---|---|---|---|---|
| Optical Density | | | | | |
| Black | 1.32 | 1.31 | 1.33 | 1.38 | 1.29 |
| Cyan | 1.36 | 1.38 | 1.40 | 1.36 | 1.36 |
| Yellow | 0.99 | 1.0 | 0.97 | 0.97 | 0.96 |
| % Show-through | | | | | |
| Black | 14 | 14 | 14 | 16 | 16 |
| Cyan | 16 | 17 | 15 | 19 | 20 |
| Yellow | 20 | 18 | 23 | 24 | 26 |
| Print Gloss | | | | | |
| | 6.6 | 6.3 | 5.9 | 5.7 | 3.9 |
| Print Definition | | | | | |
| Total Area, mm² | 3.81 | 3.97 | 3.96 | 3.91 | 4.05 |
| Optical Density | 0.66 | 0.66 | 0.66 | 0.67 | 0.66 |
| Total perimeter, mm | 32.46 | 32.90 | 33.30 | 31.70 | 33.10 |
| Color Bleed | | | | | |
| Total Area, mm² | 25.3 | 25.9 | 25.5 | 25.8 | 26.7 |
| Optical Density | 0.85 | 0.85 | 0.90 | 0.84 | 0.84 |
| Total perimeter, mm | 101.4 | 98.3 | 90.6 | 102.0 | 106.8 |

1. A coating composition for fibrous substrates comprising:
a) 0.5 to 25 percent by weight of an water-insoluble emulsion polymer comprising from 0.5 to 3 mole percent of one or more cationic monomer units, and at least 50 mole percent of one or more vinyl ester monomer units;
b) 25 to 75 percent by weight pigment;
c) water; and
d) cationic surfactant.

2. The coating composition of claim 1 wherein said emulsion polymer comprises 0.5 to 2 mole percent of one or more cationic monomer units.

3. The coating composition of claim 1 wherein said cationic monomer comprises primary, secondary, and tertiary amino groups.

4. The coating composition of claim 1 wherein said cationic monomer comprises a tertiary amino group.

5. The coating composition of claim 1 wherein said emulsion polymer comprises at least 70 mole percent of vinyl ester monomer units.

6. The coating composition of claim 1 wherein said emulsion polymer comprises at least 80 mole percent of vinyl ester monomer units.

7. The coating composition of claim 1 wherein said emulsion polymer comprises vinyl acetate monomer units.

8. The coating composition of claim 1 wherein said emulsion polymer further comprises ethylene monomer units.

9. The coating composition of claim 1 wherein said emulsion polymer further comprises up to 49.6 mole percent of other ethylenically unsaturated monomer units.

10. A coated fibrous substrate comprising a fibrous substrate having coated thereon on at least one surface a coating composition comprising a polymer comprising:
a) 0.5 to 25 percent by weight of an water-insoluble emulsion polymer comprising from 0.5 to 3 mole percent of cationic functionality;
b) 25 to 75 percent by weight pigment;
c) water; and
d) cationic surfactant.

11. The coated substrate of claim 10 wherein said fibrous substrate comprises paper, paperboard, textile, non-woven, or wood.

12. The coated substrate of claim 10 further comprising an ink or dye contacted onto the coating composition.

13. A process for producing a coated paper comprising applying to a sized paper web a coating composition comprising a polymer comprising:
a) 0.5 to 25 percent by weight of an water-insoluble hydrophilic emulsion polymer comprising from 0.5 to 3 mole percent of cationic functionality;
b) 25 to 75 percent by weight pigment;
c) water; and
d) cationic surfactant.
